(19) United States
(12) Patent Application Publication
(10) Pub. No.: US 2018/0331436 A1
(43) Pub. Date: Nov. 15, 2018

(54) REFRIGERATION CYCLE DEVICE

(71) Applicant: AGC INC., Chiyoda-ku (JP)

(72) Inventors: Hiroki Hayamizu, Tokyo (JP); Masato Fukushima, Tokyo (JP); Hirokazu Takagi, Tokyo (JP)

(73) Assignee: AGC INC., Chiyoda-ku (JP)

(21) Appl. No.: 16/044,972

(22) Filed: Jul. 25, 2018

Related U.S. Application Data
(63) Continuation of application No. PCT/JP2017/002496, filed on Jan. 25, 2017.

(30) Foreign Application Priority Data
Jan. 29, 2016 (JP) 2016-016081

(51) Int. Cl. H01R 4/70; F25B 1/04

(52) U.S. Cl. CPC H01R 4/70; F25B 1/04; F04C 2210/26; F04C 2240/803; F25B 2400/07; F25B 2500/11; F25D 2201/10; F04C 2240/40

(57) ABSTRACT

A refrigeration cycle apparatus includes a compressor to compress a working fluid containing 1,1,2-trifluoroethylene. The compressor includes a compression unit which compresses the working fluid, a driving unit which drives the compression unit, a power supply terminal which supplies electric power from an outside of the compressor to an inside of the compressor, and a plurality of lead wires which electrically connects the driving unit to the power supply terminal. Each of the plurality of lead wires is covered with an insulating material having heat resistance of 300° C. or more at least in a part where the lead wires are bundled.

### TECHNICAL FIELD

The present invention relates to a refrigeration cycle apparatus using a working fluid containing 1,1,2-trifluoroethylene.

### BACKGROUND ART

In a refrigeration cycle apparatus such as an air-conditioner or a refrigerator, a hydrofluorocarbon (HFC) based refrigerant has been widely used as a working refrigerant. However, HFCs have a high global warming potential (GWP). Thus, it is pointed out that HFCs may cause global warming. It is therefore imperative to develop a working fluid for refrigeration cycles, which has less influence on the ozone layer and has a low GWP. A working fluid containing a hydrofluoroolefin (HFO) having a carbon-carbon double bond which is likely to be decomposed by OH radicals in the air has been studied as a working fluid for refrigeration cycles having less influence on the ozone layer and having less influence on global warming. Patent Document 1 discloses a refrigeration cycle apparatus using a working fluid containing 1,1,2-trifluoroethylene (HFO-1123).

### CITATION LIST

### Patent Document

Patent Document 1: JP-A-2015-145452

### SUMMARY OF THE INVENTION

### Technical Problems

When a certain level of ignition energy is applied to HFO-1123 in a high-temperature and high-pressure state, a chain of chemical reactions with heat generation may occur. Such a chemical reaction is called disproportionation reaction (self-decomposition reaction). The disproportionation reaction is a chemical reaction in which two or more molecules belonging to the same kind react with each other to generate two or more different kinds of products. When such a disproportionation reaction occurs within a refrigeration cycle apparatus, sudden temperature rise and pressure rise occur to lose the reliability of the refrigeration cycle apparatus.

Within the refrigeration cycle apparatus, places where it is highly likely to apply a certain level of ignition energy to the working fluid under high temperature and high pressure are mainly inside a compressor. When ignition energy is generated inside the compressor due to some event such as occurrence of discharge (spark) in a driving unit, the ignition energy is applied to the working fluid so that disproportionation reactions of HFO-1123 may occur.

The present invention has been developed in consideration of the aforementioned situation. An object of the present invention is to provide a refrigeration cycle apparatus capable of effectively avoiding occurrence of disproportionation reactions of HFO-1123 when a working fluid containing the HFO-1123 is used.

### Solution to Problems

The refrigeration cycle apparatus in the first aspect of the present invention is a refrigeration cycle apparatus comprising a compressor to compress a working fluid containing 1,1,2-trifluoroethylene to perform a refrigeration cycle,

wherein the compressor includes:

a compression unit which compresses the working fluid;

a driving unit which drives the compression unit;

a power supply terminal which supplies electric power from an outside of the compressor to an inside of the compressor; and

a plurality of lead wires which electrically connect the driving unit to the power supply terminal, and

each of the plurality of lead wires is covered with an insulating material having heat resistance of 300° C. or more at least in a part where the lead wires are bundled one another.

In the refrigeration cycle apparatus in the second aspect of the present invention, the plurality of lead wires are connected to the power supply terminal through a connector, and the connector is formed of an insulating material having heat resistance of 300° C. or more.

In the refrigeration cycle apparatus in the third aspect of the present invention, the plurality of lead wires are inserted into the connector in directions of being separated from one another at angles, respectively.

The refrigeration cycle apparatus in the fourth aspect of the present invention is a refrigeration cycle apparatus comprising a compressor to compress a working fluid containing 1,1,2-trifluoroethylene to perform a refrigeration cycle,

wherein the compressor includes:

a compression unit which compresses the working fluid;

a driving unit which drives the compression unit;

a power supply terminal which supplies electric power from an outside of the compressor to an inside of the compressor;

a plurality of lead wires which electrically connect the driving unit to the power supply terminal; and

an insulating material which has heat resistance of 300° C. or more and includes a plurality of through holes disposed at distances from one another, and

each of the plurality of lead wires is disposed to allow a part of the lead wire to pass through each of the plurality of through holes of the insulating material.

In the refrigeration cycle apparatus in the fifth aspect of the present invention, the lead wires are connected to the power supply terminal through a connector, and the connector is formed of an insulating material having heat resistance of 300° C. or more.

In the refrigeration cycle apparatus in the sixth aspect of the present invention, the plurality of lead wires are inserted into the connector in directions of being separated from one another at angles, respectively.

The refrigeration cycle apparatus in the seventh aspect of the present invention is a refrigeration cycle apparatus comprising a compressor to compress a working fluid containing 1,1,2-trifluoroethylene to perform a refrigeration cycle,

wherein the compressor includes:

a compression unit which compresses the working fluid;

a driving unit which drives the compression unit;

a power supply terminal which supplies electric power from an outside of the compressor to an inside of the compressor; and

a plurality of lead wires which electrically connect the driving unit to the power supply terminal, and

the lead wires are connected to the power supply terminal through a connector, and

the connector is formed of an insulating material having heat resistance of 300° C. or more.

In the refrigeration cycle apparatus in the eighth aspect of the present invention, the plurality of lead wires are inserted into the connector in directions of being separated from one another at angles, respectively.

The refrigeration cycle apparatus in the ninth aspect of the present invention is a refrigeration cycle apparatus comprising a compressor to compress a working fluid containing 1,1,2-trifluoroethylene to perform a refrigeration cycle,

wherein the compressor includes:

a compression unit which compresses the working fluid;

a driving unit which drives the compression unit;

a power supply terminal which supplies electric power from an outside of the compressor to an inside of the compressor; and

a plurality of lead wires which electrically connect the driving unit to the power supply terminal, and

the driving unit and the power supply terminal are connected through the plurality of covered lead wires,

the lead wires are connected to the power supply terminal through a connector, and

the plurality of lead wires are inserted into the connector in directions of being separated from one another at angles, respectively.

### Advantageous Effects of the Invention

In a refrigeration cycle apparatus of the present invention, it is possible to effectively avoid occurrence of disproportionation reactions of HFO-1123 in spite of an abnormally high temperature or high pressure condition inside a refrigeration cycle when a working fluid containing the HFO-1123 is used.

### BRIEF DESCRIPTION OF THE DRAWINGS

FIG. 1 is a schematic configuration diagram illustrating an example of a refrigeration cycle apparatus in Embodiment 1.

FIG. 2 is a pressure-enthalpy chart illustrating the state change of a working fluid in the refrigeration cycle apparatus in Embodiment 1.

FIG. 3 is a longitudinal sectional view illustrating the schematic configuration of a compressor in the refrigeration cycle apparatus in Embodiment 1.

FIG. 4 is a cross sectional view taken on line IV-IV in FIG. 3.

FIG. 5 is a view for describing a general configuration of a lead wire portion in a compressor used in an existing refrigeration cycle apparatus.

FIG. 6 is view for describing a schematic configuration of a lead wire portion in the compressor used in the refrigeration cycle apparatus in Embodiment 1.

FIG. 7 is a view for describing a schematic configuration of a lead wire portion in Embodiment 2.

FIG. 8 is a view illustrating the appearance of an insulating member in the lead wire portion in Embodiment 2.

FIG. 9 is a top view of the insulating member in the lead wire portion in Embodiment 2.

FIG. 10 is a view for describing a schematic configuration of a lead wire portion in Embodiment 3.

FIG. 11 is an enlarged view of a peripheral part of a connector in the lead wire portion of the compressor used in the existing refrigeration cycle apparatus illustrated in FIG. 5.

FIG. 12 is an enlarged view of a peripheral part of a connector in a lead wire portion in Embodiment 4.

### DESCRIPTION OF EMBODIMENTS

### Embodiment 1

Embodiment 1 of the present invention is described below with reference to the drawings.

First, description is made about a working fluid for use in a refrigeration cycle apparatus in the present invention.

### <Working Fluid>

### (HFO-1123)

A working fluid used in the present invention contains 1,1,2-trifluoroethylene (HFO-1123).

First, description is made about the working fluid for use in the refrigeration cycle apparatus in the present invention.

The properties of HFO-1123 as working fluid are shown in Table 1 particularly by relative comparison with R410A (a pseudoazeotropic mixture refrigerant of HFC-32 and HFC-125 in a mass ratio of 1:1). Cycle performance is evaluated by a coefficient of performance and refrigeration capacity obtained by the later-described methods. The coefficient of performance and the refrigeration capacity of HFO-1123 are expressed by relative values (hereinafter referred to as relative coefficient of performance and relative refrigeration capacity) based on those of R410A as reference (1.000). The global warming potential (GWP) is a 100-years value shown in Intergovernmental Panel on Climate Change (IPCC), Fourth assessment report (2007), and measured in accordance with the method of the same report. In the present specification, GWP unit the value unless otherwise specified. When the working fluid is formed of a mixture, the temperature gradient is a significant factor for evaluating the working fluid, as is described later. It is preferable that the value of the temperature gradient is smaller.

TABLE 1

| | R410A | HFO-1123 |
|---|---|---|
| Relative coefficient of performance | 1.000 | 0.921 |
| Relative refrigeration capacity | 1.000 | 1.146 |
| Temperature gradient [° C.] | 0.2 | 0 |
| GWP | 2088 | 0.3 |

### [Optional Components]

The working fluid used in the present invention preferably contains HFO-1123. In addition to HFO-1123, optional compounds that are usually used as working fluids may be contained as long as they do not impair the effect of the present invention. Examples of such optional compounds (optional components) include HFCs, HFOs (HFCs each having a carbon-carbon double bond) other than HFO-1123, and other components that can be liquefied or vaporized together with HFO-1123. Preferred optional components are HFCs, and HFOs (HFCs each having a carbon-carbon double bond) other than HFO-1123.

Such an optical component is preferably a compound which can set the GWP or the temperature gradient within an acceptable range while enhancing the relative coefficient of performance and the relative refrigeration capacity when it is, for example, used in a heat cycle together with HFO-1123. When the working fluid contains such a compound together with HFO-1123, better cycle performance can be obtained while keeping the GWP low, and the influence of the temperature gradient can be reduced.

### (Temperature Gradient)

When the working fluid contains, for example, HFO-1123 and an optical component, the working fluid has a significant temperature gradient as long as HFO-1123 and the optional component do not form an azeotropic composition. The temperature gradient of the working fluid depends on the kind of the optional component and the mixture ratio between HFO-1123 and the optional component.

Usually, when a mixture is used as the working fluid, an azeotropic mixture or a pseudoazeotropic mixture such as R410A is preferably used. A non-azeotropic composition has a problem that a change in composition occurs when the composition is charged into a refrigerator/air-conditioner from a pressure vessel. Further, when a refrigerant leaks from the refrigerator/air-conditioner, there is an extremely great possibility that the composition of the refrigerant within the refrigerator/air-conditioner may change so that the composition of the refrigerant cannot be recovered to its initial state easily. On the other hand, the problem can be avoided by using an azeotropic or pseudoazeotropic mixture as the working fluid.

The “temperature gradient” is generally used as an index to evaluate availability of a mixture in the working fluid. The temperature gradient is defined as such a property that the initiation temperature and the completion temperature of evaporation in a heat exchanger such as an evaporator or of condensation in a heat exchanger such as a condenser differ from each other. The temperature gradient is 0 in an azeotropic mixture, and the temperature gradient is very close to 0 in a pseudoazeotropic mixture, for example, the temperature gradient of R410A is 0.2.

When the temperature gradient is large, there is a problem that the inlet temperature, for example, in the evaporator decreases so that frosting is more likely to occur. Further, generally in a heat cycle system, a working fluid flowing in a heat exchanger and a heat source fluid such as water or air are made to flow as counter-current flows against each other in order to improve the heat exchange efficiency. Since the temperature difference of the heat source fluid is small in a stable operation state, it is difficult to obtain a heat cycle system with a good energy efficiency when a non-azeotropic mixture fluid with a large temperature gradient is used. Accordingly, when a mixture is used as the working fluid, it is desired that the working fluid has an appropriate temperature gradient.

### (HFC)

As the HFC as the optional component, it is preferable to select an HFC from the aforementioned viewpoint. Here, an HFC is known to have a high GWP as compared with HFO-1123. Accordingly, as the HFC used in combination with HFO-1123, it is preferable to select an HFC appropriately in order not only to improve cycle performance as the working fluid and set the temperature gradient within a proper range but also to adjust particularly the GWP within an acceptable range.

As an HFC which has less influence on the ozone layer and which has less influence on global warming, an HFC having 1 to 5 carbon atoms is specifically preferred. The HFC may be linear, branched or cyclic.

Examples of the HFC include HFC-32, difluoroethane, trifluoroethane, tetrafluoroethane, HFC-125, pentafluoropropane, hexafluoropropane, heptafluoropropane, pentafluorobutane, heptafluorocyclopentane and the like.

Among them, in view of less influence on the ozone layer and excellent refrigeration cycle performance, preferable examples of the HFC include HFC-32, 1,1-difluoroethane (HFC-152a), 1,1,1-trifluoroethane (HFC-143a), 1,1,2,2-tetrafluoroethane (HFC-134), 1,1,1,2-tetrafluoroethane (HFC-134a) and HFC-125, and more preferable examples thereof include HFC-32, HFC-152a, HFC-134a and HFC-125.

One kind of HFC may be used alone or two or more kinds of HFCs may be used in combination.

The content of the HFC in the working fluid (100 mass %) may be desirably selected depending on required properties of the working fluid. When the working fluid is, for example, made of HFO-1123 and HFC-32, the coefficient of performance and the refrigeration capacity can be improved when the content of HFC-32 falls within the range of from 1 to 99 mass %. When the working fluid is made of HFO-1123 and HFC-134a, the coefficient of performance can be improved when the content of HFC-134a falls within the range of from 1 to 99 mass %.

With respect to GWP of the aforementioned preferred HFC, GWP of HFC-32 is 675, GWP of HFC-134a is 1,430, and GWP of HFC-125 is 3,500. In order to reduce the GWP of the obtainable working fluid, HFC-32 is the most preferable HFC as the optional component.

HFO-1123 and HFC-32 can form a pseudoazeotropic mixture close to an azeotropic mixture when the mass ratio between the both is from 99:1 to 1:99. The mixture of the both has a temperature gradient close to 0 substantially without selecting a composition range thereof. Also with respect to this point, HFC-32 is advantageous as an HFC to be combined with HFO-1123.

When HFC-32 is used together with HFO-1123 in the working fluid used in the present invention, specifically the content of HFC-32 based on 100 mass % of the working fluid is preferably 20 mass % or more, more preferably from 20 to 80 mass %, and further preferably from 40 to 60 mass %.

When the working fluid used in the present invention, for example, contains HFO-1123, an HFO other than HFO-1123 is preferably HFO-1234yf (GWP=4), HFO-1234ze(E) or HFO-1234ze(Z) (GWP=6 in both the (E)-isomer and the (Z)-isomer), and more preferably HFO-1234yf or HFO-1234ze(E) because they are high in critical temperature and excellent in durability and coefficient of performance. One kind of HFOs other than HFO-1123 may be used alone, or two or more kinds of them may be used in combination. The content of the HFO other than UFO-1123 in the working fluid (100 mass %) may be desirably selected depending on required properties of the working fluid. When the working fluid is, for example, made of HFO-1123 and HFO-1234yf or HFO-1234ze, the coefficient of performance can be improved when the content of HFO-1234yf or HFO-1234ze falls within the range of from 1 to 99 mass %.

When the working fluid used in the present invention contains HFO-1123 and HFO-1234yf, a preferred composition range is shown below as a composition range (S).

In the respective formulae showing the composition range (S), the abbreviation of each compound designates the proportion (mass %) of the compound to the total amount of HFO-1123, HFO-1234yf and other components (HFC-32 and the like).

### <Composition Range (S)>

HFO-1123+HFO-1234yf≥70 mass %

95 mass %≥HFO-1123/(HFO-1123+HFO-1234yf)≥35 mass %

The working fluid in the composition range (S) is extremely low in GWP and small in temperature gradient. In addition, refrigeration cycle performance high enough to replace the R410A in the background art can be exhibited also from the viewpoint of the coefficient of performance, the refrigeration capacity and the critical temperature.

In the working fluid in the composition range (S), the proportion of HFO-1123 to the total amount of HFO-1123 and HFO-1234yf is more preferably from 40 to 95 mass %, further more preferably from 50 to 90 mass %, particularly preferably from 50 to 85 mass %, and most preferably from 60 to 85 mass %.

In addition, the total content of HFO-1123 and HFO-1234yf in 100 mass % of the working fluid is more preferably from 80 to 100 mass %, further more preferably from 90 to 100 mass %, and particularly preferably from 95 to 100 mass %.

In addition, it is preferable that the working fluid used in the present invention contains HFO-1123, HFC-32 and HFO-1234yf. A preferred composition range (P) in a case where the working fluid contains HFO-1123, HFO-1234yf and HFC-32 is shown below.

In the respective formulae showing the composition range (P), the abbreviation of each compound designates the proportion (mass %) of the compound to the total amount of HFO-1123, HFO-1234yf and HFC-32. The same thing can be also applied to the composition range (R), the composition range (L) and the composition range (M). In addition, in the following composition range, it is preferable that the total amount of HFO-1123, HFO-1234yf and HFC-32 described specifically is more than 90 mass % and 100 mass % or less based on the entire amount of the working fluid for heat cycle.

### <Composition Range (P)>

70 mass≤% HFO-1123+HFO-1234yf

30 mass %≤HFO-1123≤80 mass %

0 mass %<HFO-1234yf≤40 mass %

0 mass %<HFC-32≤30 mass %

HFO-1123/HFO-1234yf≤95/5 mass %

The working fluid having the aforementioned composition is a working fluid having respective properties of HFO-1123, HFO-1234yf and HFC-32 in a balanced manner, and having less defects of the respective components. That is, the working fluid is a working fluid which has an extremely low GWP, and has a small temperature gradient and a certain performance and efficiency when used for heat cycle, and thus, favorable cycle performance is obtained by the working fluid. Here, it is preferable that the total amount of HFO-1123 and HFO-1234yf is 70 mass % or more based on the total amount of HFO-1123, HFO-1234yf and HFC-32.

A more preferred composition as the working fluid used in the present invention may be a composition containing HFO-1123 in an amount of from 30 to 70 mass %, HFO-1234yf in an amount of from 4 to 40 mass %, and HFC-32 in an amount of from 0 to 30 mass %, based on the total amount of HFO-1123, HFO-1234yf and HFC-32 and having a content of HFO-1123 in an amount of 70 mol % or less based on the entire amount of the working fluid. The working fluid within the aforementioned range is a working fluid in which self-decomposition reaction of HFO-1123 is inhibited to enhance the durability in addition to the aforementioned effect enhanced. From the viewpoint of the relative coefficient of performance, the content of HFC-32 is preferably 5 mass % or more, and more preferably 8 mass % or more.

Other preferred compositions in the case where the working fluid used in the present invention contains HFO-1123, HFO-1234yf and HFC-32 are shown below. A working fluid in which self-decomposition reaction of HFO-1123 is inhibited to enhance the durability can be obtained as long as the content of HFO-1123 is 70 mol % or less based on the entire amount of the working fluid.

A more preferred composition range (R) is shown below.

### <Composition Range (R)>

10 mass %≤HFO-1123<70 mass %

0 mass %<HFO-1234yf≤50 mass %

30 mass %<HFC-32≤75 mass %

The working fluid having the aforementioned composition is a working fluid having respective properties of HFO-1123, HFO-1234yf and HFC-32 in a balanced manner, and having less defects of the respective components. That is, the working fluid is a working fluid which has a low GWP and ensures durability while having a small temperature gradient and having a high performance and efficiency when used for heat cycle, and thus, favorable cycle performance is obtained by the working fluid.

A preferred range in the working fluid having the composition range (R) is shown below.

20 mass %≤HFO-1123<70 mass %

0 mass %<HFO-1234yf≤40 mass %

30 mass %<HFC-32≤75 mass %

The working fluid having the aforementioned composition is a working fluid having respective properties of HFO-1123, HFO-1234yf and HFC-32 in a balanced manner, and having less defects of the respective components. That is, the working fluid is a working fluid which has a low GWP and ensures durability, while having a smaller temperature gradient and having higher performance and efficiency when used for heat cycle, and thus, favorable cycle performance is obtained by the working fluid.

A more preferable range (L) in the working fluid having the composition range (R) is shown below. A composition range (M) is further more preferable.

### <Composition Range (L)>

10 mass %≤HFO-1123<70 mass %

0 mass %<HFO-1234yf≤50 mass %

30 mass %<HFC-32≤44 mass %

### <Composition Range (M)>

20 mass %≤HFO-1123<70 mass %

5 mass %≤HFO-1234yf≤40 mass %

30 mass %<HFC-32≤44 mass %

The working fluid in the composition range (M) is a working fluid having respective properties of HFO-1123, HFO-1234yf and HFC-32 in a balanced manner, and having less defects of the respective components. That is, the working fluid is a working fluid in which an upper limit of GWP is reduced to 300 or less and durability is ensured, and which has a small temperature gradient smaller than 5.8 and has a relative coefficient of performance and a relative refrigeration capacity close to 1 when used for heat cycle, and thus, favorable cycle performance is obtained by the working fluid.

Within this range, the upper limit of the temperature gradient is decreased, and the lower limit of the product of the relative coefficient of performance and the relative refrigeration capacity is increased. In order to increase the relative coefficient of performance, it is more preferable to satisfy “8 mass %≤HFO-1234yf”. In addition, in order to increase the relative refrigeration capacity, it is more preferable to satisfy “HFO-1234yf≤35 mass %”.

In addition, it is preferable that another working fluid used in the present invention contains HFO-1123, HFC-134a, HFC-125 and HFO-1234yf With this composition, flammability of the working fluid can be controlled.

More preferably, in the working fluid containing HFO-1123, HFC-134a, HFC-125 and HFO-1234yf, the proportion of the total amount of HFO-1123, HFC-134a, HFC-125 and HFO-1234yf is more than 90 mass % and 100 mass % or less based on the entire amount of the working fluid, and the proportion of HFO-1123 is 3 mass % or more and 35 mass % or less, the proportion of HFC-134a is 10 mass % or more and 53 mass % or less, the proportion of HFC-12.5 is 4 mass % or more and 50 mass % or less, and the proportion of HFO-1234yf is 5 mass % or more and 50 mass % or less, based on the total amount of HFO-1123, HFC-134a, HFC-125 and HFO-1234yf. Such a working fluid is a working fluid being non-flammable, having excellent safety, having less influence on the ozone layer and global warming, and having excellent cycle performance when used for a heat cycle system.

Most preferably, in the working fluid containing HFO-1123, HFC-134a, HFC-125 and HFO-1234yf, the proportion of the total amount of HFO-1123, HFC-134a, HFC-125 and HFO-1234yf is more than 90 mass % and 100 mass % or less based on the entire amount of the working fluid, and the proportion of HFO-1123 is 6 mass % or more and 25 mass % or less, the proportion of HFC-134a is 20 mass % or more and 35 mass % or less, the proportion of HFC-125 is 8 mass % or more and 30 mass % or less, and the proportion of HFO-1234yf is 20 mass % or more and 50 mass % or less, based on the total amount of HFO-1123, HFC-134a, HFC-125 and HFO-1234yf. Such a working fluid is a working fluid being non-flammable, having more excellent safety, having much less influence on the ozone layer and global warming, and having more excellent cycle performance when used for a heat cycle system.

### (Other Optional Components)

The working fluid used in a composition for a heat cycle system in the present invention may contain carbon dioxide, a hydrocarbon, a chlorofluoroolefin (CFO), a hydrochlorofluoroolefin (HCFO) and the like, other than the aforementioned optional component. As the other optional component, a component which has less influence on the ozone layer and has less influence on global warming is preferred.

Examples of the hydrocarbon include propane, propylene, cyclopropane, butane, isobutane, pentane, isopentane and the like.

One kind of such hydrocarbons may be used alone or two or more kinds of them may be used in combination.

When the working fluid contains a hydrocarbon, its content is less than 10 mass %, preferably from 1 to 5 mass %, and more preferably from 3 to 5 mass %, based on 100 mass % of the working fluid. When the content of the hydrocarbon is equal to or more than the lower limit, the solubility of a mineral refrigerator oil in the working fluid is more favorable.

Examples of the CFO include chlorofluoropropene, chlorofluoroethylene and the like. In order to easily control the flammability of the working fluid without significantly decreasing the cycle performance of the working fluid, the CFO is preferably 1,1-dichloro-2,3,3,3-tetrafluoropropene (CFO-1214ya), 1,3-dichloro-1,2,3,3-tetrafluoropropene (CFO-1214yb) or 1,2-dichloro-1,2-difluoroethylene (CFO-1112)

One kind of such CFOs may be used alone or two or more kinds of them may be used in combination.

When the working fluid contains the CFO, its content is less than 10 mass %, preferably from 1 to 8 mass %, and more preferably from 2 to 5 mass %, based on 100 mass % of the working fluid. When the content of the CFO is equal to or more than the lower limit, the flammability of the working fluid can be easily controlled. When the content of the CFO is equal to or less than the upper limit, favorable cycle performance is likely to be obtained.

Examples of the HCFO include hydrochlorofluoropropene, hydrochlorofluoroethylene and the like. In order to easily control the flammability of the working fluid without significantly decreasing the cycle performance of the working fluid, the HCFO is preferably 1-chloro-2,3,3,3-tetrafluoropropene (HCFO-1224yd) or 1-chloro-1,2-difluoroethyl ene (HCFO-1122).

One kind of such HCFOs may be used alone or two or more kinds of them may be used in combination.

In a case where the working fluid contains the HCFO, the content of the HCFO is less than 10 mass %, preferably from 1 to 8 mass %, and more preferably from 2 to 5 mass %, based on 100 mass % of the working fluid. When the content of the HCFO is equal to or more than the lower limit, the flammability of the working fluid can be easily controlled. When the content of the HCFO is equal to or less than the upper limit, favorable cycle performance is likely to be obtained.

When the working fluid used in the present invention contains the aforementioned other optional components, the total content of the other optional components in the working fluid is less than 10 mass %, preferably 8 mass % or less, and more preferably 5 mass % or less, based on 100 mass % of the working fluid.

### <Configuration of Refrigeration Cycle Apparatus>

Next, the schematic configuration of a refrigeration cycle apparatus in this embodiment is described.

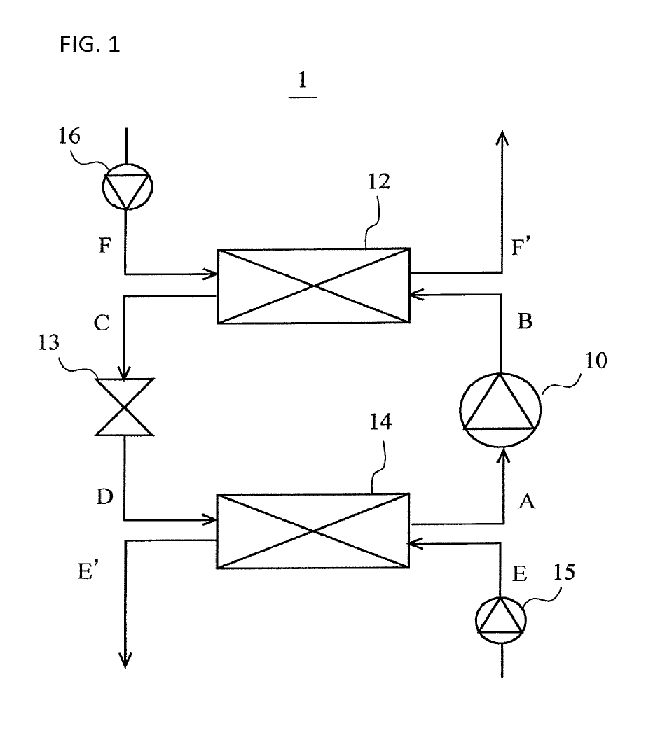

FIG. 1 is a diagram illustrating the schematic configuration of a refrigeration cycle apparatus 1 in this embodiment. The refrigeration cycle apparatus 1 includes a compressor 10, a condenser 12, an expansion mechanism 13 and an evaporator 14. The compressor 10 compresses a working fluid (vapor). The condenser 12 cools and liquefies the vapor of the working fluid discharged from the compressor 10. The expansion mechanism 13 expands the working fluid (liquid) discharged from the condenser 12, The evaporator 14 heats and vaporizes the working fluid (liquid) discharged from the expansion mechanism 13. The evaporator 14 and the condenser 12 are configured to perform heat exchange between the working fluid and a heat source fluid flowing in opposition or in parallel thereto. The refrigeration cycle apparatus 1 further includes a fluid supply unit 15 that supplies a heat source fluid E such as water or air to the evaporator 14, and a fluid supply unit 16 that supplies a heat source fluid F such as water or air to the condenser 12.

In the refrigeration cycle apparatus 1, the following refrigeration cycle is repeated. First, a working fluid vapor A discharged from the evaporator 14 is compressed by the compressor 10 to form a high-temperature and high-pressure working fluid vapor B.

Then the working fluid vapor B discharged from the compressor 10 is cooled and liquefied by the fluid F in the condenser 12 to form a working fluid liquid C. At that time, the fluid F is heated to form a fluid F′ which is discharged from the condenser 12. Successively the working fluid liquid C discharged from the condenser 12 is expanded in the expansion mechanism 13 to form a working fluid liquid D which is in low temperature and low pressure. Successively the working fluid liquid D discharged from the expansion mechanism 13 is heated by the fluid E in the evaporator 14 to form a working fluid vapor A. At that time, the fluid E is cooled to form a fluid E′ which is discharged from the evaporator 14.

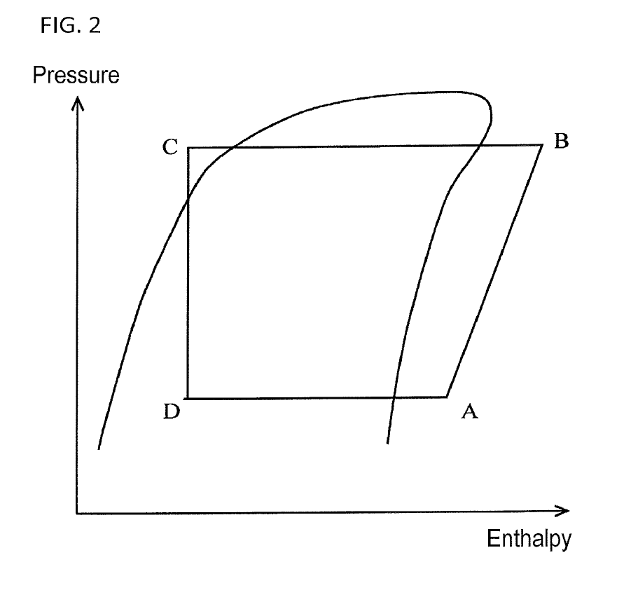

FIG. 2 is a pressure-enthalpy chart illustrating the state change of the working fluid in the refrigeration cycle apparatus 1. As illustrated in FIG. 2, in the process of a state change from A to B, adiabatic compression is carried out by the compressor 10 to change the low-temperature and low-pressure working fluid vapor A to the high-temperature and high-pressure working fluid vapor B. In the process of a state change from B to C, isobaric cooling is carried out in the condenser 12 to change the working fluid vapor B to the working fluid liquid C. In the process of a state change from C to D, isenthalpic expansion is carried out by the expansion mechanism 13 to change the high-temperature and high-pressure working fluid liquid C to the low-temperature and low-pressure working fluid liquid D. In the process of a state change from D to A, isobaric heating is carried out in the evaporator 14 to return the working fluid liquid D to the working fluid vapor A.

Next, the configuration of the compressor 10 is described.

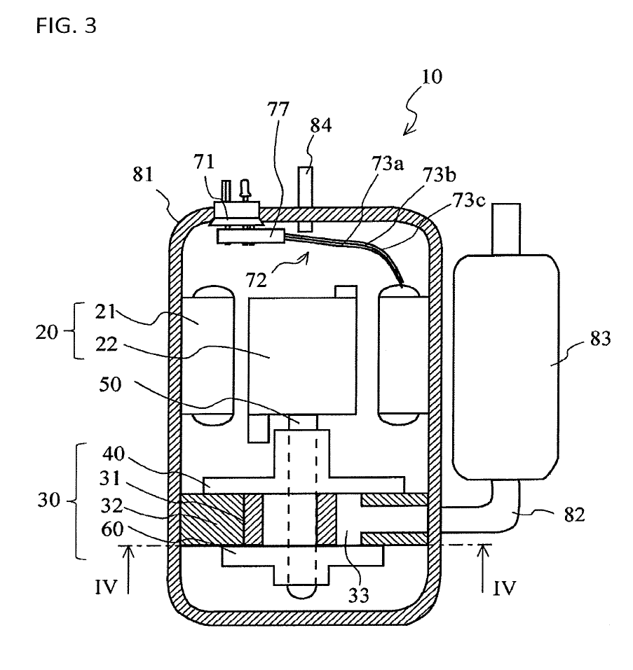

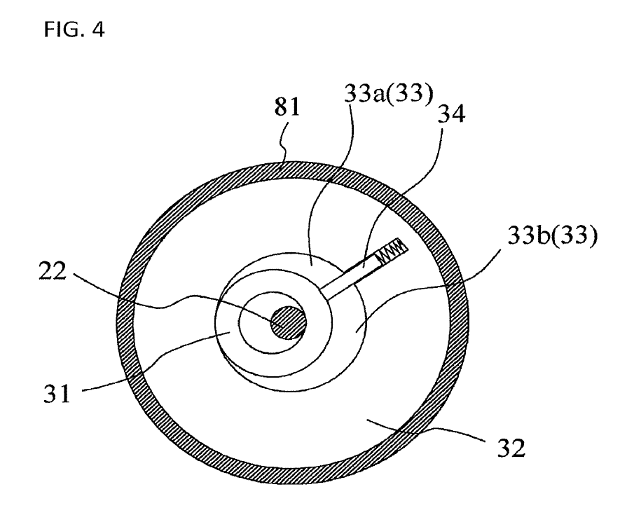

FIG. 3 is a longitudinal sectional view illustrating the schematic configuration of the compressor 10. FIG. 4 is a cross sectional view taken on line IV-IV in FIG. 3. Here, in this embodiment, description is made along an example in which the compressor 10 is a rotary compressor. As illustrated in FIG. 3 and FIG. 4, the compressor 10 includes a casing 81, a compression unit 30 that compresses a low-temperature and low-pressure working fluid (gas) sucked from an accumulator 83 through a suction pipe 82, and a driving unit 20 that drives the compression unit 30. As illustrated in FIG. 3, in the internal space of the casing 81, the driving unit 20 is disposed on the upper side, and the compression unit 30 is disposed on the lower side. The driving force of the driving unit 20 is transmitted to the compression unit 30 through a driving shaft 50.

As illustrated in FIG. 3, the compression unit 30 includes a roller 31, a cylinder 32, an upper closing member 40 and a lower closing member 60. The roller 31 is disposed inside the cylinder 32. A compression chamber 33 is formed between the inner circumferential surface of the cylinder 32 and the roller 31. As illustrated in FIG. 4, the compression chamber 33 is divided into two compression chambers 33a and 33b by a vane 34. One end of the vane 34 is urged toward the outer circumference of the roller 31 by an urging unit such as a spring provided at the other end of the vane 34.

As illustrated in FIG. 3, the upper closing member 40 closes the upper side of the cylinder 32. The lower closing member 60 closes the lower side of the cylinder 32. In addition, the upper closing member 40 and the lower closing member 60 serve as bearing to pivotally support the later-described driving shaft 50. The driving unit 20 is, for example, a three-phase induction motor which includes a stator 21 and a rotor 22. The stator 21 is fixed in contact with the inner circumferential surface of the casing 81. The stator 21 has an iron core, and a winding wire wound on the iron core through an insulating member. The rotor 22 is placed inside the stator 21 so as to put a predetermined gap therefrom. The rotor 22 has an iron core and a permanent magnet.

As illustrated in FIG. 3, a power supply terminal 71 that supplies electric power from the outside of the compressor 10 to the inside thereof is attached to the inside of an upper portion of the casing 81. The electric power is supplied to the stator 21 of the driving unit 20 from the power supply terminal 71 through a lead wire portion 72. Thus, the rotor 22 of the driving unit 20 rotates so that the driving shaft 50 fixed to the rotor 22 rotationally drives the roller 31 of the compression unit 30. The lead wire portion 72 has lead wires 73a, 73b and 73c, and a connector (cluster block) 77. The lead wires 73a, 73b and 73c electrically connect the driving unit 20 to the power supply terminal 71. The connection between the power supply terminal 71 and the lead wires 73a, 73b and 73c is carried out through the connector 77. The configuration of the lead wire portion 72 is described later in detail.

As illustrated in FIG. 3, when the roller 31 is rotationally driven inside the compression chamber 33, the working fluid in the compression chamber 33 is compressed. A discharge valve is provided in the upper closing member 40. The high-temperature and high-pressure working refrigerant compressed inside the compression chamber 33 is discharged from a discharge pipe 84 through the discharge valve.

The refrigeration cycle apparatus 1 uses the working fluid containing HFO-1123, as described above. When a certain level of ignition energy is applied to HFO-1123 in a high-temperature and high-pressure state, a chain of chemical reactions with heat generation may occur. Such a chemical reaction is called disproportionation reaction (self-decomposition reaction). The disproportionation reaction is a chemical reaction in which two or more molecules belonging to the same kind react with each other to generate two or more different kinds of products. When such a disproportionation reaction occurs within a refrigeration cycle apparatus, sudden temperature rise and pressure rise occur to lose the reliability of the refrigeration cycle apparatus.

Within the refrigeration cycle apparatus 1 described in FIG. 1, places where it is highly likely to apply a certain level of ignition energy to the working fluid under high temperature and high pressure are mainly inside the compressor 10. Inside the compressor 10 illustrated in FIG. 3, as one of the places where ignition energy may be applied to the working fluid under high temperature and high pressure, short-circuiting between different phases in an electric part (the lead wire portion 72) may occur.

Before description about the configuration of the lead wire portion 72 in the compressor 10 of the refrigeration cycle apparatus 1 in this embodiment, description is first made about a general configuration of a lead wire portion in a compressor used in an existing refrigeration cycle apparatus, and problems in the configuration.

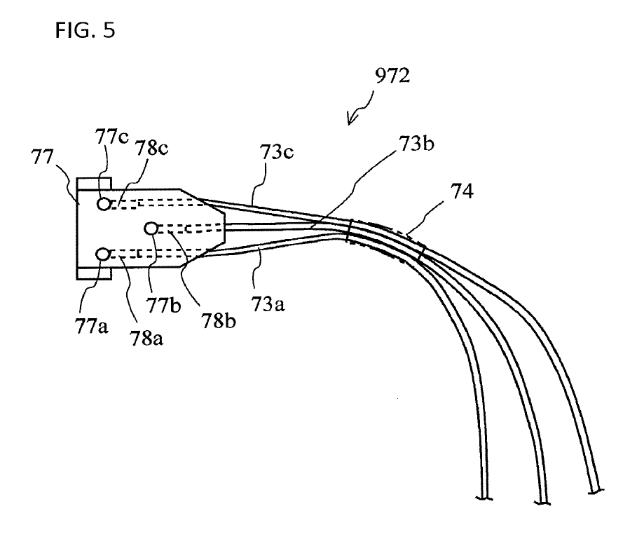

FIG. 5 is a view for describing the general configuration of a lead wire portion 972 in a compressor used in an existing refrigeration cycle apparatus. As illustrated in FIG. 5, the lead wire portion 972 has lead wires 73a, 73b and 73c, and a connector 77. Insertion terminals 78a, 78b and 78c are attached to front end portions of the lead wires 73a, 73b and 73c. The insertion terminals 78a, 78b and 78c are covered with the connector 77 formed of a resin. Terminal insertion holes 77a, 77b and 77c are formed in the connector 77. The lead wires 73a, 73b and 73c are inserted into the connector 77 so that the front ends of the insertion terminals 78a, 78b and 78c reach the positions of the terminal insertion holes 77a, 77b and 77c, respectively. Terminals of the power supply terminal 71 (see FIG. 3) are inserted into the terminal insertion holes 77a, 77b and 77c, respectively.

The lead wires 73a, 73b and 73c are bundled in their intermediate portions by a bundling member 74 such as a transparent tube. The lead wires 73a, 73b and 73c are bundled chiefly in order to improve the workability and to prevent the lead wires from abutting a sliding portion of the compressor to be thereby damaged.

Phases of voltages in the lead wires 73a, 73b and 73c differ from one another. Therefore, there is a large potential difference among the lead wires. When coatings of the lead wires are damaged for some reason at the parts where the lead wires 73a, 73b and 73c are bundled by the bundling member 74, the lead wires are short-circuited to generate discharge (spark). The coatings of the lead wires may be damaged, for example, because the coatings of the lead wires are melted by abnormal electric conduction to the compressor. During the operation of the refrigeration cycle apparatus, the lead wire portion 972 is exposed to the atmosphere of a working fluid which is in high temperature and high pressure. In a case where a working fluid containing HFO-1123 is used as the working fluid of the refrigeration cycle apparatus, when discharge is generated by short-circuiting among the lead wires 73a, 73b and 73c, ignition energy caused by the discharge is applied to the working fluid which is in high temperature and high pressure. Thus, disproportionation reaction of HFO-1123 may occur. In order to avoid the occurrence of disproportionation reaction of HFO-1123, it is necessary to avoid the discharge caused by short-circuiting in the lead wire portion 972.

Next, description is made about the configuration of the lead wire portion 72 in the compressor 10 of the refrigeration cycle apparatus 1 in this embodiment.

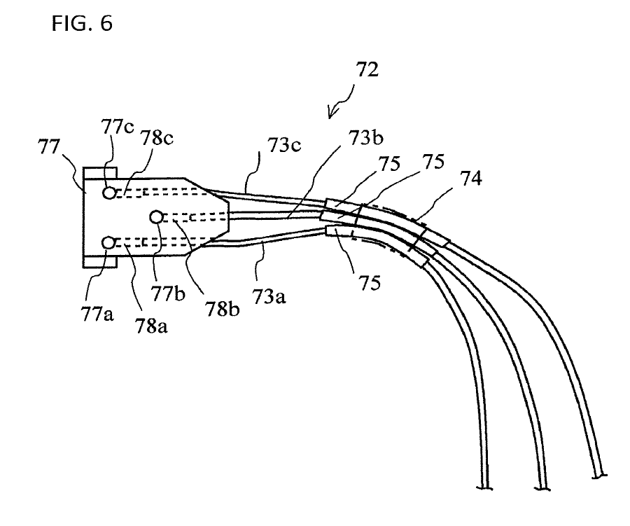

FIG. 6 is a view for describing the schematic configuration of the lead wire portion 72 in the compressor 10 of the refrigeration cycle apparatus 1 in this embodiment. Constituent elements shared with those in the lead wire portion 972 illustrated in FIG. 5 are referenced correspondingly, and their descriptions are omitted. As illustrated in FIG. 6, the lead wires 73a, 73b and 73c are bundled in their intermediate portions by the bundling member 74 such as a transparent tube. Each of the lead wires 73a, 73b and 73c is covered with insulating materials 75 in the parts where the lead wires 73a, 73b and 73c are bundled by the bundling member 74. The insulating materials 75 have heat resistance of 300° C. or more.

Since each of the parts where the lead wires 73a, 73b and 73c are bundled by the bundling member 74 is covered with the insulating materials 75 having heat resistance of 300° C. or more, the lead wires 73a, 73b and 73c can be inhibited from short-circuiting to thereby occur discharge even if the coatings in the parts where the lead wires 73a, 73b and 73c are bundled by the bundling member 74 are melted due to abnormal electric conduction to the compressor. As a result, when the working fluid containing HFO-1123 is used, it is possible to effectively avoid the occurrence of disproportionation reaction of HFO-1123.

### Embodiment 2

Embodiment 2 of the present invention is described below with reference to the drawings.

A refrigeration cycle apparatus in this embodiment is the same as the refrigeration cycle apparatus 1 described in Embodiment 1 with reference to FIG. 1. In addition, the schematic configuration of a compressor used in the refrigeration cycle apparatus in this embodiment is fundamentally the same as the compressor 10 described in Embodiment 1 with reference to FIG. 3. The compressor in this embodiment is different from the compressor 10 in Embodiment 1 as to the configuration of a lead wire portion.

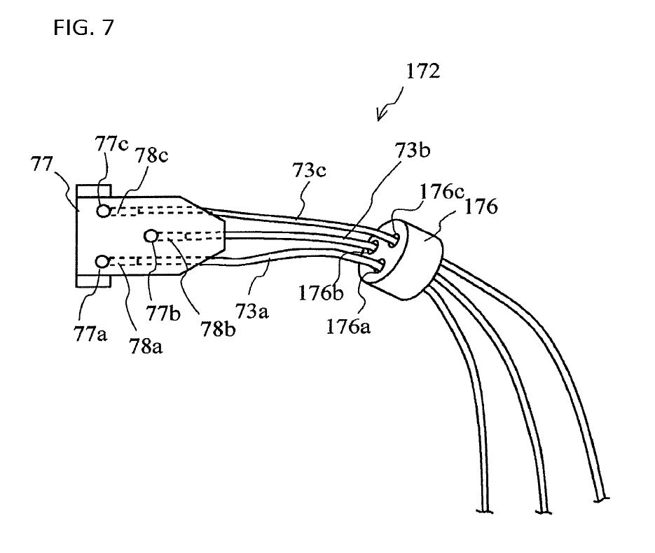

FIG. 7 is a view for describing the schematic configuration of a lead wire portion 172 in this embodiment. Constituent elements shared with those in the lead wire portion 72 in Embodiment 1 illustrated in FIG. 6 are referenced correspondingly, and their descriptions are omitted. As illustrated in FIG. 7, lead wires 73a, 73b and 73c are bundled in their intermediate portions by an insulating member 176 which has heat resistance of 300° C. or more.

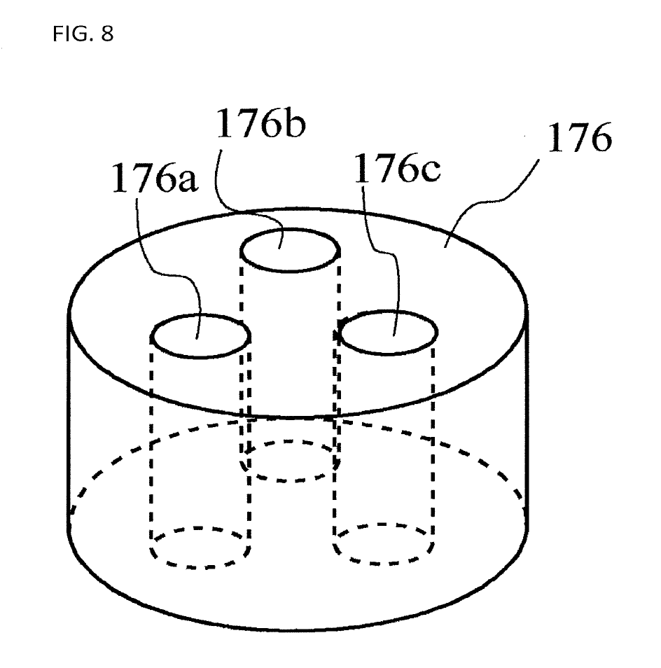

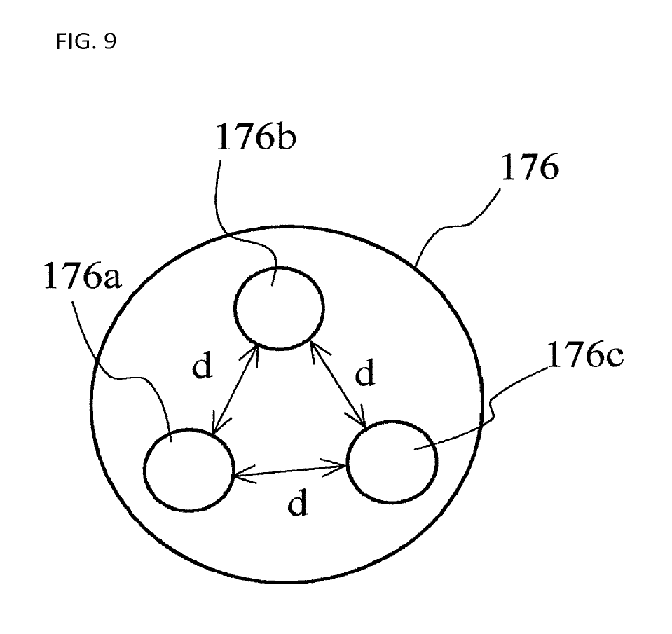

FIG. 8 is a perspective view of the appearance of the insulating member 176. FIG. 9 is a top view of the insulating member 176. As illustrated in FIG. 8 and FIG. 9, through holes 176a, 176b and 176c the number (three) of which is the same as the number (three) of the lead wires 73a, 73b and 73c are formed inside the cylindrical insulating member 176. The diameter of each of the through holes 176a, 176b, and 176c is set to have a size enough to allow one lead wire to pass therethrough. As illustrated in FIG. 9, the through holes 176a, 176b and 176c formed in the insulating member 176 are disposed at a predetermined distance d from one another.

As illustrated in FIG. 7, the plurality of the lead wires 73a, 73b and 73c are disposed to allow a part of them to pass through the different through holes, respectively. That is, a part of the lead wire 73a is disposed so as to pass through the through hole 176a, a part of the lead wire 73b is disposed so as to pass through the through hole 176b, and a part of the lead wire 73c is disposed so as to pass through the through hole 176c.

The lead wires 73a, 73b and 73c are bundled by the insulating member 176 so as to be separated from one another by a distance enough not to bring them into contact with one another. Thus, the lead wires 73a, 73b and 73c can be prevented from short-circuiting due to contact with one another to thereby occur discharge even if the coatings of the lead wires 73a, 73b and 73c are melted due to abnormal electric conduction to the compressor. As a result, it is possible to effectively avoid occurrence of disproportionation reactions of HFO-1123 when a working fluid containing the HFO-1123 is used.

The shape of the insulating member 176 is not limited to the cylindrical shape. For example, it may be a spherical shape. In addition, the number of insulating members 176 to be attached to the lead wires 73a, 73b and 73c is not limited to one but may be plural as long as the lead wires can be separated from one another by a distance enough not to bring them into contact with one another.

### Embodiment 3

Embodiment 3 of the present invention is described below with reference to the drawings.

A refrigeration cycle apparatus in this embodiment is the same as the refrigeration cycle apparatus 1 described in Embodiment 1 with reference to FIG. 1. In addition, the schematic configuration of a compressor used in the refrigeration cycle apparatus in this embodiment is fundamentally the same as the compressor 10 described in Embodiment 1 with reference to FIG. 3. The compressor in this embodiment is different from the compressor 10 in Embodiment 1 as to the configuration of a lead wire portion.

In the lead wire portion 972 of the compressor used in the existing refrigeration cycle apparatus illustrated in FIG. 5, the connector 77 is formed of a resin whose heat resistance is not sufficient. It has been confirmed by experiments that, upon abnormal electric conduction to the compressor, the connector 77 may be melted in the lead wire portion 972 before the coatings of the lead wires 73a, 73b and 73c are melted. When the connector 77 is melted, there is a fear that the insertion terminals 78a, 78b and 78c attached to the front ends of the lead wires 73a, 73b and 73c, respectively, come into contact with one another to thereby occur discharge.

As described above, the refrigeration cycle apparatus 1 uses the working fluid containing HFO-1123. When the insertion terminals 78a, 78b and 78c come into contact with one another to thereby occur discharge during the operation of the refrigeration cycle apparatus, there is a fear that ignition energy caused by the discharge may be applied to the working fluid under high temperature and high pressure so as to cause disproportionation reactions of HFO-1123 inside the compressor 10 illustrated in FIG. 3. In order to avoid the occurrence of disproportionation reactions of HFO-1123, it is necessary to inhibit the insertion terminals 78a, 78b and 78c from coming into contact with one another to thereby occur discharge.

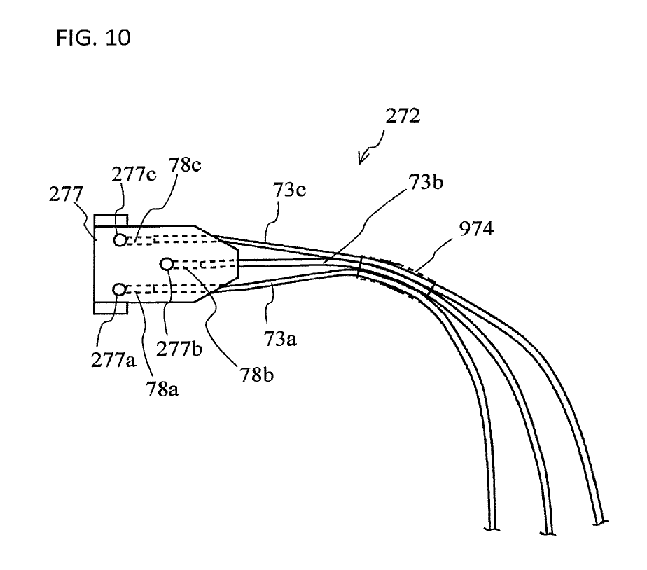

FIG. 10 is a view for describing the schematic configuration of a lead wire portion 272 in this embodiment. Constituent elements shared with those in the lead wire portion 972 illustrated in FIG. 5 are referenced correspondingly, and their descriptions are omitted. The configuration of a connector 277 is fundamentally the same as the configuration of the connector 77 illustrated in FIG. 5 (terminal insertion holes 277a, 277b and 277c of the connector 277 correspond to the terminal insertion holes 77a, 77b and 77c of the connector 77), but different therefrom as to the material of the connector. The connector 277 is formed of an insulating material having heat resistance of 300° C. or more.

The material of the connector 277 may be a wire material which is 180(H), 200(N), 220(R), or 250 in thermal class defined in JIS C4003. Examples of the main material thereof include a material having high heat resistance, such as mica, asbestos, alumina, silica glass, quartz, magnesium oxide, polytetrafluoroethylene, and silicone rubber. In addition, examples of the main material thereof include polyimide resin, polybenzimidazole resin, polyether ether ketone resin, polyphenylene sulfide resin, nylon resin, polybutylene terephthalate resin, polyether imide resin, polyamide imide resin, allyl resin, diallyl phthalate resin, acetyl cellulose resin, cellulose acetate resin, and the like. One kind of those heat resistant materials may be used alone, but it is preferable that two or more kinds of them are used in combination in order to provide excellent heat resistance.

In addition, silicon resin may be used as an impregnation coating material or an insulating treatment material used for manufacturing the heat resistant material wires. When the impregnation coating material or the insulating treatment material is used together with the aforementioned heat resistant materials, an auxiliary function such as improvement in insulation can be expressed.

When an insulating material having heat resistance of 300° C. or more is used as the material of the connector 277, it is possible to avoid melting of the connector 277 due to abnormal electric conduction to the compressor. It is therefore possible to avoid contact among the insertion terminals 78a, 78b and 78c at the front ends of the lead wires 73a, 73b and 73c and the occurrence of discharge caused thereby. As a result, it is possible to effectively avoid occurrence of disproportionation reactions of HFO-1123 when a working fluid containing the HFO-1123 is used.

### Embodiment 4

Embodiment 4 of the present invention is described below with reference to the drawings.

A refrigeration cycle apparatus in this embodiment is the same as the refrigeration cycle apparatus 1 described in Embodiment 1 with reference to FIG. 1. In addition, the schematic configuration of a compressor used in the refrigeration cycle apparatus in this embodiment is fundamentally the same as the compressor 10 described in Embodiment 1 with reference to FIG. 3. The compressor in this embodiment is different from the compressor 10 in Embodiment 1 as to the configuration of a lead wire portion.

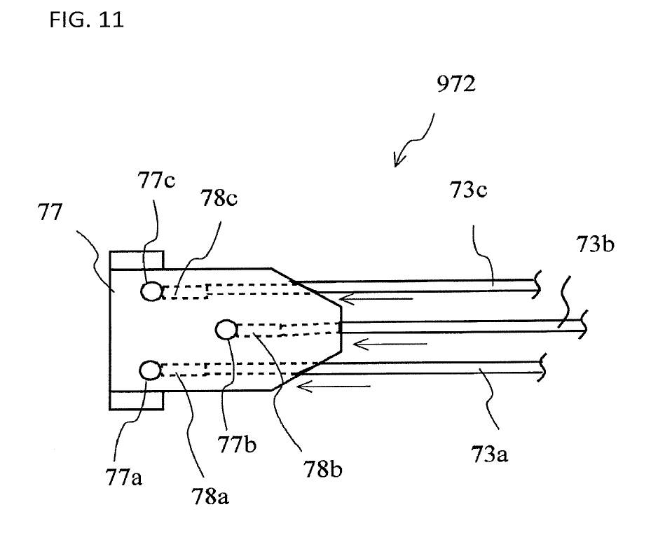

FIG. 11 is an enlarged view of a peripheral part of the connector 77 in the lead wire portion 972 of the compressor used in the existing refrigeration cycle apparatus illustrated in FIG. 5. As illustrated in FIG. 11, the lead wires 73a, 73b and 73c are inserted into the connector 77 in parallel with one another. When the lead wires 73a, 73b and 73c are inserted into the connector 77 in parallel with one another, distances of the insertion terminals 78a, 78b and 78c from one another are short. Thus, there is a fear that the insertion terminals 78a, 78b and 78c may come into contact with one another to thereby occur discharge in such a case where the connector 77 is melted due to abnormal electric conduction to the compressor.

As described above, the refrigeration cycle apparatus 1 uses the working fluid containing HFO-1123. When the insertion terminals 78a, 78b and 78c come into contact with one another to thereby occur discharge during the operation of the refrigeration cycle apparatus, there is a possibility that ignition energy caused by the discharge may be applied to the working fluid under high temperature and high pressure so as to lead to occurrence of disproportionation reactions of HFO-1123 inside the compressor 10 illustrated in FIG. 3. In order to avoid the occurrence of disproportionation reactions of HFO-1123, it is necessary to inhibit the insertion terminals 78a, 78b and 78c from coming into contact with one another to thereby occur discharge.

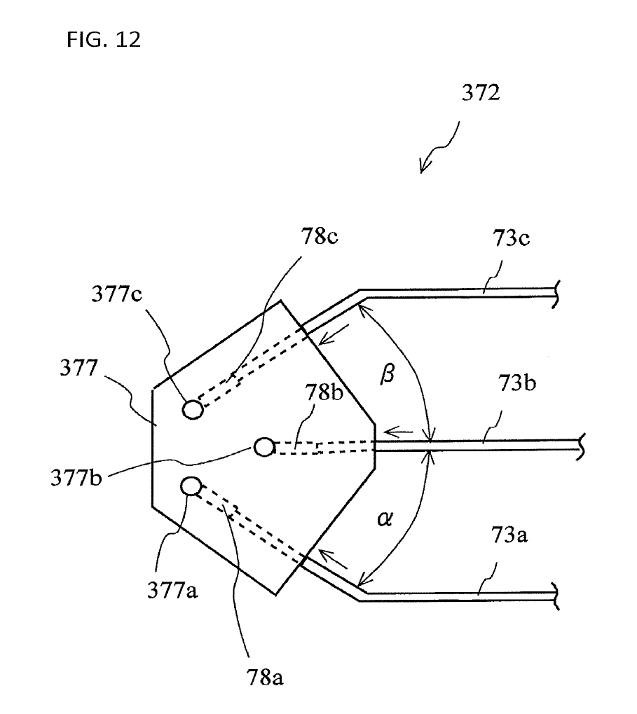

In comparison with the lead wire portion 972 of the compressor used in the existing refrigeration cycle apparatus illustrated in FIG. 5, lead wires 73a, 73b and 73c are inserted in a form where distances among insertion terminals are not short, in a lead wire portion in this embodiment. FIG. 12 is an enlarged view of a peripheral part of a connector 377 of a lead wire portion 372 in this embodiment. As illustrated in FIG. 12, in the lead wire portion 372 in this embodiment, the lead wires 73a, 73b and 73c are inserted into the connector 377 in directions of being separated from one another at angles, respectively. Specifically, the lead wire 73a and the lead wire 73b are inserted in the directions of being separated from each other at an angle α. The lead wire 73b and the lead wire 73c are inserted in the directions of being separated from each other at an angle β. In order to improve workability and prevent the lead wires from being caught by a sliding portion of the compressor, it is preferable that each of the angle α and the angle β is an angle of 90 degrees or less.

When the lead wires 73a, 73b and 73c are inserted into the connector 377 in directions of being separate from one another at angles, respectively, the distances among the insertion terminals can be increased so that the insertion terminals 78a, 78b and 78c at the front ends of the lead wires 73a, 73b and 73c can be inhibited from coming into contact with one another to thereby occur discharge. As a result, it is possible to effectively avoid occurrence of disproportionation reactions of HFO-1123 when a working fluid containing the HFO-1123 is used.

The present invention is not limited to the aforementioned embodiments, but may be changed suitably without departing from the gist of the present invention. For example, although the aforementioned embodiments are described on the assumption that the compressor of the refrigeration cycle apparatus is a rotary compressor, the present invention is not limited thereto. For example, the compressor may be a scroll compressor. Although the motor of the driving unit in the compressor is a three-phase induction motor in the aforementioned embodiments, it may be, for example, a brushless DC (Direct Current) motor.

In addition, the embodiments may be combined with one another suitably. For example, Embodiment 3 or Embodiment 4 may be combined with Embodiment 1. Embodiment 3 or Embodiment 4 may be combined with Embodiment 2.

Although the present invention has been described in detail and along its specific embodiments, it is obvious for those skilled in the art that various changes or modifications can be made on the present invention without departing from the spirit and scope of the present invention. The present application is based on a Japanese patent application No. 2016-16081 filed on Jan. 29, 2016, the contents of which are incorporated herein by reference.

### DESCRIPTION OF REFERENCE NUMERALS AND SIGNS

1 Refrigeration cycle apparatus
10 Compressor
12 Condenser
13 Expansion mechanism
14 Evaporator
20 Driving unit
30 Compression unit
31 Roller
32 Cylinder
40 Upper closing member
60 Lower closing member
73a, 73b, 73c Lead wire
74 Bundling member
75 Insulating material
77 Connector
78a, 78b, 78c Insertion terminals
81 Casing

1. A refrigeration cycle apparatus comprising a compressor to compress a working fluid containing 1,1,2-trifluoroethylene,
wherein the compressor includes:
a compression unit which compresses the working fluid;
a driving unit which drives the compression unit;
a power supply terminal which supplies electric power from an outside of the compressor to an inside of the compressor; and
a plurality of lead wires which electrically connect the driving unit to the power supply terminal, and
each of the plurality of lead wires is covered with an insulating material having heat resistance of 300° C. or more at least in a part where the lead wires are bundled one another.

2. The refrigeration cycle apparatus according to claim 1, wherein:
the plurality of lead wires are connected to the power supply terminal through a connector; and
the connector is formed of an insulating material having heat resistance of 300° C. or more.

3. The refrigeration cycle apparatus according to claim 2, wherein the plurality of lead wires are inserted into the connector in directions of being separated from one another at angles, respectively.

4. A refrigeration cycle apparatus comprising a compressor to compress a working fluid containing 1,1,2-trifluoroethylene to perform a refrigeration cycle,
wherein the compressor includes:
a compression unit which compresses the working fluid;
a driving unit which drives the compression unit;
a power supply terminal which supplies electric power from an outside of the compressor to an inside of the compressor;
a plurality of lead wires which electrically connect the driving unit to the power supply terminal; and
an insulating material which has heat resistance of 300° C. or more and includes a plurality of through holes disposed at distances from one another, and
each of the plurality of lead wires is disposed to allow a part of the lead wire to pass through each of the plurality of through holes of the insulating material.

5. The refrigeration cycle apparatus according to claim 4, wherein:
the lead wires are connected to the power supply terminal through a connector; and
the connector is formed of an insulating material having heat resistance of 300° C. or more.

6. The refrigeration cycle apparatus according to claim 5, wherein the plurality of lead wires are inserted into the connector in directions of being separated from one another at angles, respectively.

7. A refrigeration cycle apparatus comprising a compressor to compress a working fluid containing 1,1,2-trifluoroethylene to perform a refrigeration cycle,
wherein the compressor includes:
a compression unit which compresses the working fluid;
a driving unit which drives the compression unit;
a power supply terminal which supplies electric power from an outside of the compressor to an inside of the compressor; and
a plurality of lead wires which electrically connect the driving unit to the power supply terminal, and
the lead wires are connected to the power supply terminal through a connector, and
the connector is formed of an insulating material having heat resistance of 300° C. or more.

8. The refrigeration cycle apparatus according to claim 7, wherein the plurality of lead wires are inserted into the connector in directions of being separated from one another at angles, respectively.

9. A refrigeration cycle apparatus comprising a compressor to compress a working fluid containing 1,1,2-trifluoroethylene to perform a refrigeration cycle,
wherein the compressor includes:
a compression unit which compresses the working fluid;
a driving unit which drives the compression unit;
a power supply terminal which supplies electric power from an outside of the compressor to an inside of the compressor; and
a plurality of lead wires which electrically connect the driving unit to the power supply terminal, and
the driving unit and the power supply terminal are connected through the plurality of lead wires,
the lead wires are connected to the power supply terminal through a connector, and
the plurality of lead wires are inserted into the connector in directions of being separated from one another at angles, respectively.
